(19) United States
(12) Patent Application Publication
(10) Pub. No.: US 2007/0106976 A1
(43) Pub. Date: May 10, 2007

(54) Re-wiring component assemblies in component based user applications

(75) Inventors: Michael D. Facemire, Cary, NC (US); Eric L. Masselle, Raleigh, NC (US); Patrick G. McGowan, Chapel Hill, NC (US); Shankar Ramaswamy, Chapel Hill, NC (US); Amber Roy-Chowdhury, Cary, NC (US); Michael C. Wanderski, Durham, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/268,326

(22) Filed: Nov. 7, 2005

(51) Int. Cl. G06F 9/44

(52) U.S. Cl. 717/106

(57) ABSTRACT

Embodiments of the present invention address deficiencies of the art in respect to assembling an application using a component based model and provide a method, system and computer program product for re-wiring component based assemblies in a component based computing environment. In one embodiment, a data processing system for re-wiring component assemblies of component based user applications can include a component aggregation application configured to aggregate multiple components in an aggregation, a property broker coupled to the component aggregation application and configured to establish wires between selected ones of the components in the aggregation; and, re-wiring logic. The re-wiring logic can include program code enabled to re-wire selected ones of the components in the aggregation.

### BACKGROUND OF THE INVENTION

1. Field of the Invention

The present invention relates to the field of component based user applications and more particularly to the assembly of different components to produce a component based user application.

2. Description of the Related Art

Component based user applications address the rigid nature of unitary, consolidated applications which are programmed to support a particular application need without providing substantial flexibility. In the unitary, consolidated application, little can be done if the particular application needs change. By comparison, in component based computing, different components provide atomic elements of application functionality. Individual components can be combined with other components to dynamically assemble an application which provides a specific type of functionality to flexibly support a particular application need, even as the application needs change. Examples of component based computing implementations include collaborative computing applications and portal computing environments.

Portal frameworks support a component based model for building user facing applications. Portal applications represent assemblies of user-facing components which can be combined in different ways to produce different applications. Portlets are the visibly active, user-facing components included as part of portal pages. Similar to the graphical windows paradigm of windowing operating systems, each portlet in a portal occupies a portion of the portal page through which the portlet can display associated content from a portlet channel. The prototypical portlet can be implemented as a server-side script executed through a portal server.

Portal servers are computer programs which facilitate the distribution of portal based Web sites on the public Internet or a private intranet. Importantly, it will be recognized by one of ordinary skill in the art that the signature characteristic of all conventional portal servers can include the aggregation of content from several portlet applications within a single distributable page in a uniform manner. To that end, each portlet application within the portal page can be represented by a portlet user interface distributed by the portal server to requesting client computing devices.

Cooperative portlets subscribe to a model for declaring, publishing and sharing information with one another using a property broker. Portlets can subscribe to the broker by publishing typed data items or properties that can be shared by the portlet, either as a provider or as a recipient. Generally, a portlet that provides a property is referred to as a source portlet, a portlet that receives a property is referred to as a target portlet, the properties published by the source portlet are referred to as output properties, and the properties that are received by a target portlet are referred to as input properties.

Properties can be exchanged among portlets through a peristent connection referred to as a wire. Using the wire, property transfers can be effectuated between connected portlets. At runtime, a property broker can match the data type of output properties from a source portlet with the data type of input properties from one or more target portlets coupled to the source portlet over separate wires. If a match is determined, the portlets are capable of sharing the property. The actual transfer of the property over the wire can be initiated through the use of a portlet wiring tool, or by establishing a click-to-action event for the source portlet as it is known in the art.

Currently, assemblies of portlets are statically associated with a specific wiring scheme. While the static assembly of portlets using a specific wiring scheme can be useful in many cases, circumstances may arise which would benefit from a more dynamic association of assemblies of portlets which utilize wiring schemes to provide flexibility in producing an application.

### BRIEF SUMMARY OF THE INVENTION

Embodiments of the present invention address deficiencies of the art in respect to assembling an application using a component based model and provide a novel and non-obvious method, system and computer program product for re-wiring component based assemblies in a component based computing environment. In one embodiment, a data processing system for re-wiring component assemblies of component based user applications can include a component aggregation application configured to aggregate multiple components in an aggregation, a property broker coupled to the component aggregation application and configured to establish wires between selected ones of the components in the aggregation; and, re-wiring logic. The re-wiring logic can include program code enabled to re-wire selected ones of the components in the aggregation.

In one aspect of the embodiment, the component aggregation application can be a portal server and the components can be portlets. In another aspect of the embodiment, the component aggregation application can be a collaborative environment and the components can be collaborative application components. In either circumstance, the program code of the re-wiring logic can be enabled to re-wire selected ones of the components in the aggregation based responsive to a change in characterization of the aggregation. For instance, the change in characterization of the aggregation can be a change in role for a user of the aggregation. As another example, the change in characterization of the aggregation can be a change in activity for the components of the aggregation.

In another embodiment of the invention, a method for re-wiring component assemblies of component based user applications can include selecting multiple components for assembly in an aggregation of components. Optionally, the method further can include wiring the components according to a first wiring scheme defined in a template. Finally, responsive to detecting a change in characterization of the aggregation, the components can be re-wired according to a second wiring scheme defined in another template. In this regard, wiring the components according to a second wiring scheme responsive to detecting a change in characterization of the aggregation, can include wiring the components according to a second wiring scheme responsive to detecting a change in role for a user of the aggregation or responsive to detecting a change in activity for the components of the aggregation.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a data processing system for re-wiring an assembly of components in a component based user application;

FIG. 2A is a flow chart illustrating a process for re-wiring an assembly of components in a component based user application in a collaborative environment; and,

FIG. 2B is a flow chart illustrating a process for re-wiring an assembly of components in a component based user application in a portal environment.

### DETAILED DESCRIPTION OF THE INVENTION

Embodiments of the present invention provide a method, system and computer program product for re-wiring an assembly of components in a component based user application. In accordance with an embodiment of the present invention, a wiring scheme for an assembly of components can be re-wired responsive to a characteristic change in the use of the component based user application. The characteristic change can include a change in role for a user of the component based user application. Alternatively, the characteristic change can include a change in activity for the component based user application. In this way, properties exchanged between wired portlets can change according to the change in characteristic for the component based user application.

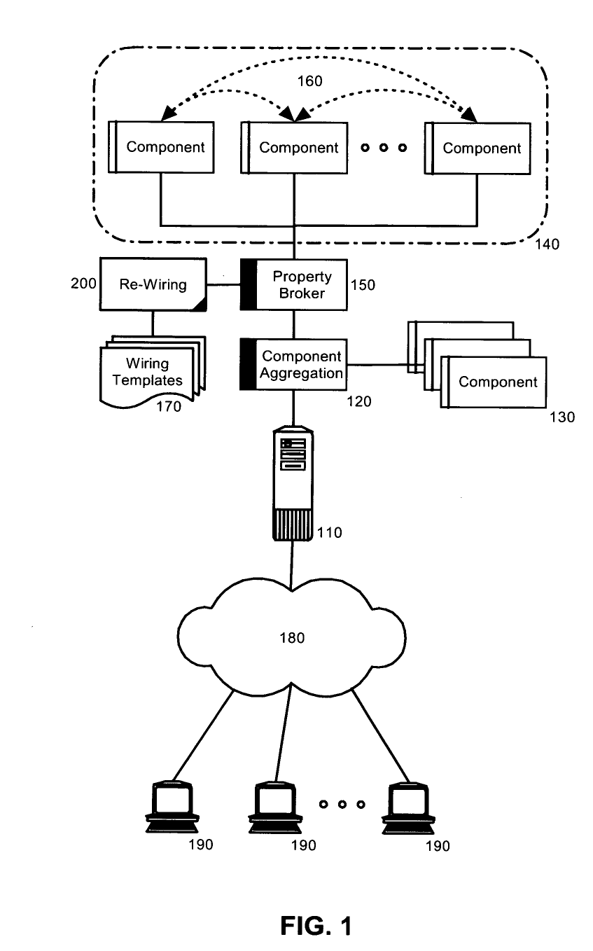

In more particular illustration, FIG. 1 is a schematic illustration of a data processing system for re-wiring an assembly of components in a component based user application. The data processing system can include a host computing platform 110 coupled to one or more client computing devices 190 over a computer communications network 180. The host computing platform 110 can include a component aggregation application 120, for example a portal server enabled to aggregate one or more components 130 into an aggregation 140. As another example, the aggregation application 120 can include a workplace server enabled to generate a collaborative environment 140 of different collaborative components 130, such as instant messengers, chat rooms, shared documents, and the like.

Notably, a wiring scheme 160 can be established for the components 130 of the aggregation 140 through a property broker 150 as it is well-known in the art. Optionally, the wiring scheme 160 can be defined in a wiring template 170. The wiring scheme 160 can permit the sharing of properties between source and target components wired together by the property broker 150. Notwithstanding, in accordance with the present invention, additional wiring schemes can be defined for the components 130 of the aggregation 140, for example through the use of additional wiring templates 170. In this regard, re-wiring logic 200 can be coupled to the property broker 150 and can include program code enabled to establish a different wiring scheme for the components 130 of the aggregation 140 based upon a change in characterization of the aggregation 140.

Exemplary changes in the characterization of the aggregation 140 can include a change in role for a user accessing the aggregation 140 over the computer communications network 180. Further exemplary changes in the characterization of the aggregation 140 can include a change in an activity conducted utilizing the components 130 of the aggregation 140, for instance a change in workflow. Other variations in the characterization of the aggregation 140 will be apparent to the skilled artisan based upon the foregoing exemplary embodiments.

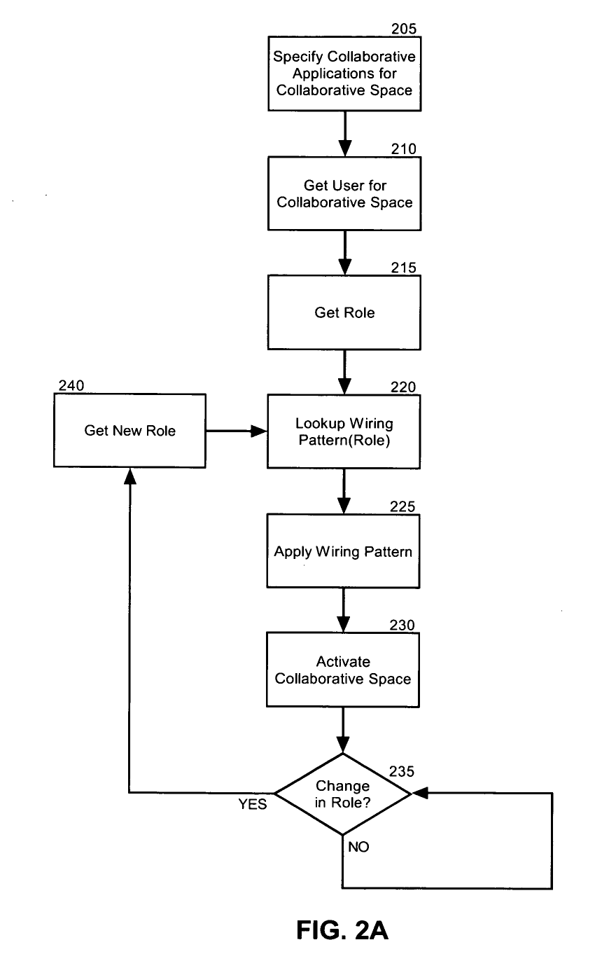

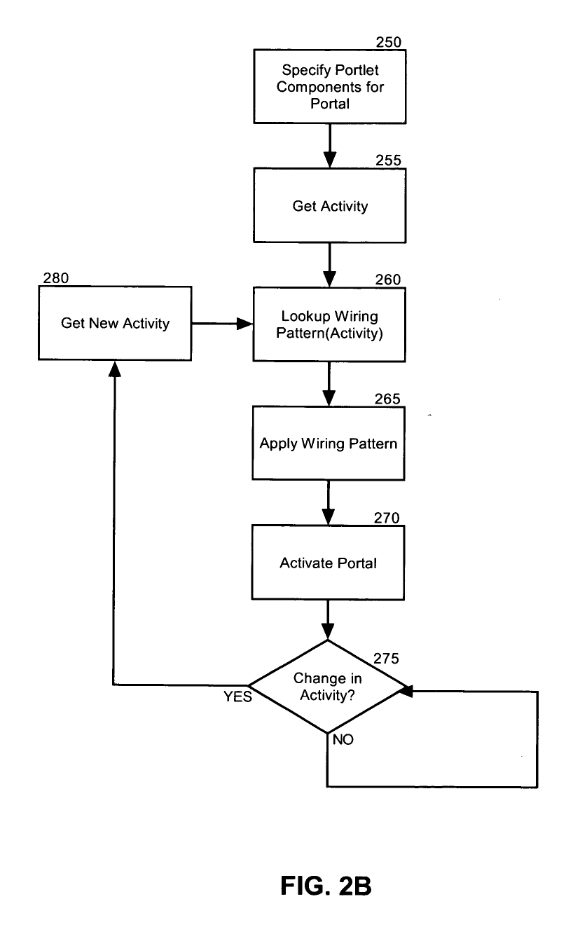

In more particular illustration of an exemplary embodiment, FIG. 2A is a flow chart illustrating a process for re-wiring an assembly of components in a component based user application in a collaborative environment. Beginning in block 205, a set of collaborative applications can be specified for use in a collaborative space. The collaborative applications can include those applications intended for use and for modification by different users and can include shared document libraries, real-time communications tools and the like.

In block 210, a user can be identified for the collaborative space. Subsequently, in block 215, a role can be determined for the user of the collaborative space. Based upon the role, in block 220 a wiring pattern can be identified and, in block 225, the identified wiring pattern can be applied to the components of the collaborative space. Specifically, different wires can be established as between different ones of the components in the collaborative space so as to provide for the sharing of properties between source and target ones of the components in the collaborative space. Subsequently, in block 230 the collaborative space can be activated for use by the user.

In decision block 235, it can be determined whether a change in role has occurred for the user. If not, the process can continue until a change in role is detected. When a change in role is detected in decision block 235, in block 240 the new role can be identified and a new wiring pattern can be retrieved for the new role in block 220. Subsequently, in block 225 the new wiring pattern can be applied to the components in the collaborative space and the newly re-wired collaborative space can be activated for use by the user in block 230. This process can repeat for each change in role detected in decision block 235.

Turning now to FIG. 2B, another exemplary embodiment is shown in the flow chart which illustrates a process for re-wiring an assembly of components in a component based user application in a portal environment. Beginning in block 250, a set of portlet components can be specified for use in a portal page. The portlet components can include those portlets intended for use and for modification by a user through a portal page.

In block 255, an activity can be identified for the portal page. Based upon the activity, in block 260 a wiring pattern can be identified and, in block 265, the identified wiring pattern can be applied to the portlets of the portal page. Specifically, different wires can be established as between different ones of the portlets in the portal page so as to provide for the sharing of properties between source and target ones of the portlets in the portal page. Subsequently, in block 270 the portal page can be rendered for use by a requesting user.

In decision block 275, it can be determined whether a change in activity or workflow has occurred for the portal page. If not, the process can continue until a change in activity or workflow is detected. When a change in activity or workflow is detected in decision block 275, in block 280 the new activity or workflow can be identified and a new wiring pattern can be retrieved for the new activity or workflow in block 260. Subsequently, in block 265 the new wiring pattern can be applied to the portlets in the portal page and the newly re-wired portal page can be rendered for use by a requesting user in block 270. This process can repeat for each change in activity or workflow detected in decision block 275.

It will be recognized by the skilled artisan that, unlike the static wiring of components in a conventional component based user application, great flexibility in the interaction among components in a component based user application can be provided by the dynamic re-wiring of the present invention. Moreover, applying new wiring patterns based upon recognized changes in the characterization of component based user applications can provide an additional level of automation and flexibility for component based user applications.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A data processing system for re-wiring component assemblies of component based user applications, the system comprising:
a component aggregation application configured to aggregate a plurality of components in an aggregation;
a property broker coupled to the component aggregation application and configured to establish wires between selected ones of the components in the aggregation; and,
re-wiring logic comprising program code enabled to re-wire selected ones of the components in the aggregation.

2. The system of claim 1, wherein the component aggregation application is a portal server and the components are portlets.

3. The system of claim 1, wherein the component aggregation application is a collaborative environment and the components are collaborative application components.

4. The system of claim 1, wherein the program code of the re-wiring logic is enabled to re-wire selected ones of the components in the aggregation based responsive to a change in characterization of the aggregation.

5. The system of claim 4, wherein the change in characterization of the aggregation is a change in role for a user of the aggregation.

6. The system of claim 4, wherein the change in characterization of the aggregation is a change in activity for the components of the aggregation.

7. The system of claim 4, wherein the program code of the re-wiring logic is enabled to apply a wiring template to the aggregation which wiring template corresponds to the change in characterization of the aggregation.

8. A method for re-wiring component assemblies of component based user applications, the method comprising:
selecting a plurality of components for assembly in an aggregation of components;
wiring the components according to a first wiring scheme; and,
responsive to detecting a change in characterization of the aggregation, wiring the components according to a second wiring scheme.

9. The method of claim 8, wherein selecting a plurality of components for assembly in an aggregation of components, comprises selecting a plurality of portlet components for assembly in a portal page aggregation.

10. The method of claim 8, wherein selecting a plurality of components for assembly in an aggregation of components, comprises selecting a plurality of collaborative components for assembly in an aggregation in a collaborative environment.

11. The method of claim 8, wherein wiring the components according to a second wiring scheme responsive to detecting a change in characterization of the aggregation, comprises wiring the components according to a second wiring scheme responsive to detecting a change in role for a user of the aggregation.

12. The method of claim 8, wherein wiring the components according to a second wiring scheme responsive to detecting a change in characterization of the aggregation, comprises wiring the components according to a second wiring scheme responsive to detecting a change in activity for the components of the aggregation.

13. A computer program product comprising a computer usable medium having computer usable program code for re-wiring component assemblies of component based user applications, said computer program product including:
computer usable program code for selecting a plurality of components for assembly in an aggregation of components;
computer usable program code for wiring the components according to a first wiring scheme; and,
computer usable program code for responsive to detecting a change in characterization of the aggregation, wiring the components according to a second wiring scheme.

14. The computer program product of claim 13, wherein the computer usable program code for selecting a plurality of components for assembly in an aggregation of components, comprises computer usable program code for selecting a plurality of portlet components for assembly in a portal page aggregation.

15. The computer program product of claim 13, wherein the computer usable program code for selecting a plurality of components for assembly in an aggregation of components, comprises computer usable program code for selecting a plurality of collaborative components for assembly in an aggregation in a collaborative environment.

16. The computer program product of claim 13, wherein the computer usable program code for wiring the components according to a second wiring scheme responsive to detecting a change in characterization of the aggregation, comprises computer usable program code for wiring the components according to a second wiring scheme responsive to detecting a change in role for a user of the aggregation.

17. The computer program product of claim 13, wherein the computer usable program code for wiring the components according to a second wiring scheme responsive to detecting a change in characterization of the aggregation, comprises computer usable program code for wiring the components according to a second wiring scheme responsive to detecting a change in activity for the components of the aggregation.
